(19) United States
(12) Patent Application Publication
(10) Pub. No.: US 2023/0358106 A1
(43) Pub. Date: Nov. 9, 2023

(54) PROTECTIVE ROLLER CENTRALIZER

(71) Applicant: Timur Rustamovich AKCHURIN, Moscow (RU)

(72) Inventor: Timur Rustamovich AKCHURIN, Moscow (RU)

(21) Appl. No.: 17/433,002

(22) PCT Filed: Oct. 28, 2020
(86) PCT No.: PCT/RU2020/050299

§ 371 Date: Oct. 14, 2021

(30) Foreign Application Priority Data
Apr. 8, 2020 (RU) 2020113103

(51) Int. Cl. E21B 17/10

(52) U.S. Cl. CPC E21B 17/1057

(57) ABSTRACT

The invention relates to the field of petroleum engineering and can be used during hydrocarbon production in directional, deviated, horizontal and complex-profile wells. A protective roller centralizer with a cable channel is provided, which comprises: a housing, inside which the cable channel extends longitudinally to the housing along the entire length of the housing; a clamping half-yoke made of at least two parts which are installed in a mirror-like manner and adjacent to each other. The at least two parts are pivotally connected to the housing on one side and are configured to be attached to each other on another side by means of a detachable fastening connection to form an inner cavity for accommodating a tubing pipe. The housing and the clamping half-yoke have ribs formed on their outer surface.

### TECHNICAL FIELD

The invention relates to the field of petroleum engineering, particularly to a protective roller centralizer/roller protector for cable lines, and can be used during hydrocarbon production in deviated, curved, horizontal and complex-profile wells.

### BACKGROUND

Currently, the main type of production wells is represented by vertical-horizontal branched complex-profile wellbores which have horizontal and complex-profile sections within oil and gas reservoirs. Such wells are built to obtain maximum oil recovery and production rate. Furthermore, the most important current trend consists in recovering idle or low-rate wells by drilling additional deviated and horizontal sections. Such methods for hydrocarbon extraction allow one to significantly increase the production rate and the coefficient of oil recovery from the reservoir. At the same time, the qualified application of the methods can significantly improve the quality of geological exploration and reduce associated costs and increase manyfold the hydrocarbon production by a borehole method. When implementing this method without the use of special equipment, it is problematic to solve the most complex technical problems.

One of the main problems consists in running and lifting a tubing string and a submersible pump into and from a horizontal well section.

When performing round-trip operations in horizontal well sections having a great length (for example, more than 1000 meters), tubing pipes having a length of 8 to 10 meters sag under their own weight. In this case, the contact area between the tubing pipes and a casing column increases. The friction forces of the tubing pipe against the casing column become so great that they make further running impossible - the weight of vertical pipes is not enough for further movement. The so-called “unloading” of the tubing string takes place. All this significantly complicates the round-trip operations in wells having a horizontal section. This complication can lead to pipe sticking due to the adhesion of the tubing string to the wall of a production string because of well sanding-up during the well operation, thereby making it difficult or even impossible to subsequently extract the tubing string together with downhole equipment to the surface.

This circumstance also often causes damage to cable lines - the cable is stripped and damaged when it is between the tubing pipe and the casing column of the well. Additionally, the increased wear of the tubing string and its damage are caused by the eccentric position of the tubing pipe in the well.

Solutions similar to the present invention are known in the prior art.

For example, RU 124302 discloses a centralizer for securing an electric cable to the body of a tubing pipe. The centralizer comprises a housing with a cable channel and a cover made which is designed as at least one clamping half-yoke and form, when connected to the housing, an internal cavity for accommodating the tubing pipe.

The disadvantage of the device known from RU 124302 is that it does not sufficiently reduce the friction forces and eccentricity of the tubing string in the horizontal well sections.

EP 1246996 B1 discloses a device for friction reduction during round-trip operations in a well. The device comprises a housing with at least one clamping half-yoke (the housing consists of half-parts). The half-yoke is pivotally connected to the housing on one side and is attached to the housing by means of a detachable fastening connection on another side. The housing and the clamping half-yokes are equipped with rollers. The device has one or more channels for the passage of liquid.

Various devices for centering drill pipes, casing pipes and tubing pipes in a well and reducing their longitudinal friction in the well are also known from WO 2012138813, EP 0778914, EP 1029146, EP 0824629.

The disadvantage of these known devices is that all of them do not sufficiently reduce the eccentric position of the tubing string, thereby increasing the wear of the tubing string and causing its damage.

### SUMMARY

The technical result achieved when implementing the present invention consists in reducing the eccentric position of a tubing string and increasing the operational device characteristics due to the absence of tubing displacement, thereby reducing damage to a tubing pipe and a cable line during round-trip operations.

The above-indicated technical result is achieved by a proposed protective roller centralizer with a cable channel. The protective roller centralizer comprises: a housing, inside which the cable channel extends longitudinally to the housing along the entire length of the housing; a clamping half-yoke made of at least two parts which are installed in a mirror-like manner and adjacent to each other. The at least two parts are pivotally connected to the housing on one side and are configured to be attached to each other on another side by means of a detachable fastening connection to form an inner cavity for accommodating a tubing pipe. The housing and the clamping half-yoke have ribs formed on the outer surface. The ribs are equipped with rollers arranged in pairs along the center of the ribs and uniformly around the circumference of the protective roller centralizer. Longitudinal bypass channels are formed on the outer surface of the housing and the clamping half-yoke between the ribs.

Moreover, the protective roller centralizer with the cable channel may be made of steel or cast iron, which increases the operational characteristics of the device.

By implementing the cable channel longitudinally to the housing along the entire length of the housing, by providing the housing and the clamping half-yoke with the ribs on the outer surface, which are equipped with the rollers arranged in pairs in the center of the ribs and uniformly around the circumference of the protective roller centralizer, and by forming the longitudinal bypass channels on the outer surface of the housing and the clamping half-yoke between the ribs, it is possible to reduce the eccentric position of tubing strings, which, in turn, reduces the tubing string wear and damage and improves the operational characteristics of the protective roller centralizer.

The cable channel extends inside the housing longitudinally to the housing and along the entire length of the housing, which allows the cable to be arranged inside the protective roller centralizer without displacement of the tubing string relative to the central axis of the protective roller centralizer, which, in turn, reduces eccentricity and increases the operational characteristics of the device.

The cable line is hidden in the housing and extends evenly along the entire length of the housing, which simplifies the arrangement of the cable line in the device, prevents bends of the cable line during the device installation and operation, provides the tightness of fastening, as well as increases the reliability of fastening the cable line together with the tubing pipe and the operational characteristics of the device.

The arrangement of the rollers in pairs in the center of the ribs and uniformly around the circumference of the protective roller centralizer improves the centering of the tubing string in the well and increases the operational characteristics of the device.

Furthermore, the arrangement of the rollers in pairs in the center of the ribs and uniformly around the circumference of the protective roller centralizer increases the reliability, maneuverability and centering of tubing pipes and downhole equipment in deviated, curved, horizontal and complex-profile wells and, as a result, increases protection against damage during the round-trip operations, thereby increasing the operational characteristics of the device.

The arrangement of the longitudinal bypass channels between the ribs uniformly around the circumference of the protective roller centralizer also improves the centering of the tubing string in the well, serves to reduce the eccentric position of the tubing string, increases the operational characteristics of the device, and reduces damage to the tubing pipe and the cable line during the round-trip operations due to the absence of displacement.

The clamping half-yoke consists of the at least two parts, which are installed in a mirror-like manner and adjacent to each other. Since at least one (two, three, four and more) clamping half-yoke is formed, the reliability of securing the cable line and tubing pipe is increased, as well as their protection from damage is improved.

### BRIEF DESCRIPTION OF THE DRAWINGS

The essence of the invention is explained by the drawings, in which:

FIG. 1 shows a general view of a protective roller centralizer with a cable channel during round-trip operations in a well when parts of a clamping half-yoke are closed;

FIG. 2 shows a general view of the protective roller centralizer with the cable channel during the round-trip operations in the well when the parts of the clamping half-yoke are open;

FIG. 3 shows a general view of the protective roller centralizer with the cable channel during the round-trip operations in the well when the protective roller centralized is mounted on a pipe together with a submersible cable line;

FIG. 4 shows a general view of the protective roller centralizer with the cable channel during the round-trip operations in the well when the protective roller centralizer is mounted on the pipe together with the submersible cable line (in the cross-section of the pipe and the cable line).

### DETAILED DESCRIPTION

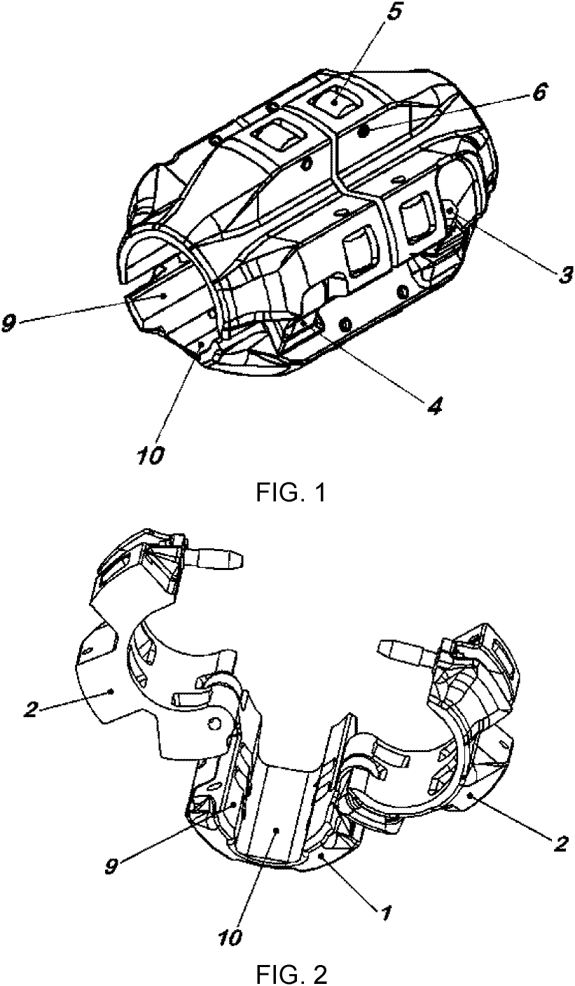

A protective roller centralizer with a cable channel during round-trip operations in a well (see FIGS. 1-4) is a housing 1 comprising at least one clamping half-yoke 2 which, when connected to the housing, forms an internal cavity 9 for accommodating a tubing pipe 7 and a cable channel 10 used for accommodating a cable line 8. The clamping half-yoke 2 is made of at least two parts which are installed in a mirror-like manner and adjacent to each other. The at least two parts are attached to the housing 1 on one side by means of a pivot joint 4 and are configured to be attached to each other on another side by means of a detachable fastening connection 3. The housing 1 and the clamping half-yoke 2 have ribs (not shown in the figures) formed on the outer surface. The ribs are equipped with rollers 5 arranged in pairs in the center of the ribs and uniformly around the circumference of the protective roller centralizer. Longitudinal bypass channels 11 are formed on the outer surface of the housing 1 and the clamping half-yoke 2 between the ribs. The rollers 5 are fixed on axles 6.

The protective roller centralizer with the cable channel is installed on the tubing pipe during the round-trip operations in the well as follows.

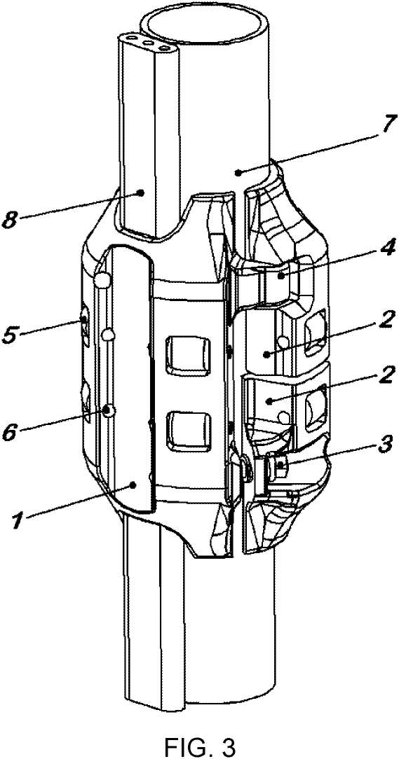

The parts of the clamping half-yoke 2 are disconnected from each other by unscrewing the detachable connection 3. In this case, the parts of the clamping half-yoke 2, which are pivotally connected to the housing 1, are not disconnected (see FIG. 2). The housing 1 is installed on the tubing pipe 7, i.e., the tubing pipe 7 is arranged in the cavity 9, and the parts of the half-yoke 2 are fastened to each other by means of the bolted detachable connection 3. The cable line 8 is pressed against the tubing pipe 7 by using the cable channel 10 (see FIG. 3).

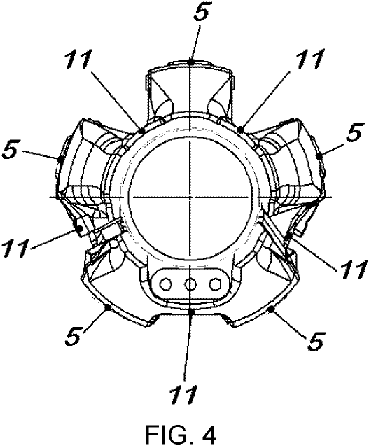

The central axis of the tubing pipe 7 coincides with the central axis of the outer dimension of the installed protective roller centralizer with the cable channel during the round-trip operations in the well. In this case, the rollers 5 protrude relative to the housing 1 and (the parts of) the clamping half-yoke 2, thereby reducing the eccentricity of the tubing string and the coefficient of friction. The longitudinal bypass channels 11 for the passage of liquid are arranged between the rollers 5 (see FIG. 4).

The protective roller centralizer with the cable channel in the well is tightened when installing the detachable bolted connection so that the tubing pipe and cable lines remain inside this device.

Thus, the protective roller centralizer with the cable channel is installed in the well on the body of the tubing pipe and the cable lines.

The proposed design of the protective roller centralizer with the cable channel in the well is reusable.

What is claimed is:

1. A protective roller centralizer with a cable channel, comprising:
a housing, inside which the cable channel extends longitudinally to the housing and along an entire length of the housing;
a clamping half-yoke made of two parts which are installed in a mirror-like manner and adjacent to each other, the two parts being pivotally connected to the housing on one side and configured to be attached to each other on another side by means of a detachable fastening connection to form an inner cavity for accommodating a tubing pipe,
wherein the housing and the clamping half-yoke are made with ribs on an outer surface, the ribs being equipped with rollers arranged in pairs in a center of the ribs and uniformly around a circumference of the protective centralizer,
wherein longitudinal bypass channels are formed on the outer surface of the housing and the clamping half-yoke between the ribs.

2. The protective roller centralizer with the cable channel according to claim 1, wherein the protective roller centralizer is made of steel or cast iron.
